(19) United States
(12) Patent Application Publication
(10) Pub. No.: US 2025/0329924 A1
(43) Pub. Date: Oct. 23, 2025

(54) ANTENNA CONNECTOR

(71) Applicant: F TIME TECHNOLOGY INDUSTRIAL CO., LTD., New Taipei City (TW)

(72) Inventors: CHANG-LIN PENG, NEW TAIPEI CITY (TW); CHIH-MIN PENG, NEW TAIPEI CITY (TW); YU-HAN HUANG, NEW TAIPEI CITY (TW)

(21) Appl. No.: 18/638,117

(22) Filed: Apr. 17, 2024

(51) Int. Cl. H01Q 1/50; H01R 13/502; H01R 13/52

(52) U.S. Cl. CPC H01Q 1/50; H01R 13/502; H01R 13/5202; H01R 2201/02

(57) ABSTRACT

An antenna connector has a casing, a shaft, a first rubber ring, and a second rubber ring. An antenna is mounted on the shaft. The shaft can rotate relative to the casing. The casing has a first flange. The shaft has a first groove, a second flange, and a second groove. The second groove is formed on the surface of the second flange. The first rubber ring fits the first groove, the surface of the perforation, the first contact surface and the second contact surface, exerted with two axial compression forces and one radial compression force concurrently. The second rubber ring fits the second groove and the casing and so is exerted with one radial compression force. Therefore, as the antenna is rotated, the first rubber ring and the second rubber ring provide a larger torque.

### BACKGROUND OF THE INVENTION

### 1. Field of the Invention

The present invention relates to an antenna connector.

### 2. Description of the Prior Arts

With the reference to FIG. 9, a conventional antenna system has a connector 90 connecting a device 91 and an antenna 92. The connector 90 transmits signals between the device 91 and the antenna 92. The connector 90 includes a rubber ring 93 that has good flexibility, wear resistance, and deformation recovery. The rubber ring 93 is fitted into a groove of a metal shaft 94. Then the rubber ring 93 and the metal shaft 94 are placed into a plastic casing 95, and the metal shaft 94 and the plastic casing 95 apply an axial compression force to the rubber ring 93. Due to the flexibility of the rubber ring 93, a torsion is generated as the metal shaft 94 is rotating axially relative to the plastic casing 95. Therefore, the antenna 92 can be adjusted to an angle to get a wider signal transmission range or receive a clearer signal.

However, if the antenna 92 is heavy, the torsion generated by a single axial compression might be too small, such that the antenna 92 will fall with the gravity and cannot maintain the angle as the antenna 92 is tilted. This makes the antenna 92 unable to remain at an optimal angle for transmitting or receiving signals.

To overcome the shortcomings, the present invention provides an antenna connector 90 to mitigate or obviate the aforementioned problems.

### SUMMARY OF THE INVENTION

The main objective of the present invention is to provide an antenna connector that is configured to electrically connect an antenna and a device, and the antenna connector is capable of keeping the antenna at any angle as desired.

The antenna connector has a casing, a shaft, a first rubber ring, and a second rubber ring. The casing is located between the antenna and the device. The casing is securely mounted on the device. The casing comprises a perforation and a first flange. A cross-section of the perforation is circular. The first flange is a loop and is mounted on a surface of the perforation. The first flange comprises a first contact surface and a second contact surface. The first contact surface is a cylindrical surface and is parallel to the surface of the perforation. The second contact surface connects the first contact surface and the surface of the perforation. The second contact surface is a surface on the first flange, and the second contact surface is closer to the antenna than the first contact surface.

The shaft is mounted through the perforation and is capable of rotating relative to the casing. A cross-section of the shaft is circular. The antenna is securely mounted on the shaft. The shaft comprises a first groove, a second flange, and a second groove. The first groove surrounds and is formed on an outer surface of the shaft. The second flange surrounds and is mounted on the outer surface of the shaft. The second flange is between the antenna and the casing and fitly contacts the casing. The second groove is formed on a surface of the second flange and located between the second flange and the casing.

The first rubber ring fits the first groove, the surface of the perforation, and the first contact surface and the second contact surface of the first flange. The second rubber ring fits the second groove and the casing.

The benefit of the present invention is that both the first rubber ring and the second rubber ring are exerted with compression forces from the shaft and the casing. Precisely, the first groove and the surface of the perforation apply one axial compression force to the first rubber ring, the first groove and the first contact surface apply another axial compression force to the first rubber ring, and the first groove and the second contact surface apply one radial compression force to the first rubber ring. The second groove and the casing apply another radial compression force to the second rubber ring. Therefore, as the antenna is rotating, the first rubber ring and the second rubber ring can provide a larger torque value and can prevent the antenna from falling with the heavy weight of the antenna.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of an antenna connector in accordance with the present invention, shown with an antenna and a device;

FIG. 2 is a perspective view of the antenna connector in FIG. 1;

FIG. 3 is an exploded view of the antenna connector in FIG. 1;

FIG. 4 is an exploded and sectional view of the antenna connector in FIG. 1;

FIG. 5 is a sectional view of the antenna connector in FIG. 1;

FIG. 6 is a sectional view of the antenna connector across line 6-6 in FIG. 5;

FIG. 7 is an enlarged view of the encircled area “7” in FIG. 5 of the antenna connector;

FIG. 8 is a sectional view of the antenna connector across line 8-8 in FIGS. 5; and

FIG. 9 is a sectional view of a conventional antenna connector.

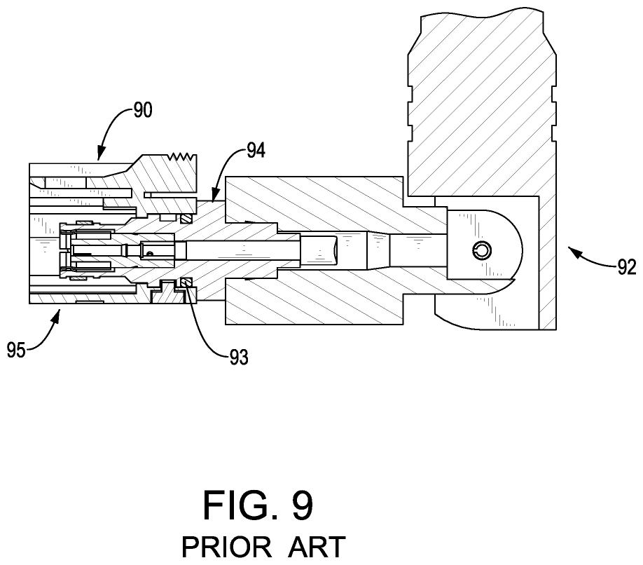

### DETAILED DESCRIPTION OF THE PREFERRED EMBODIMENTS

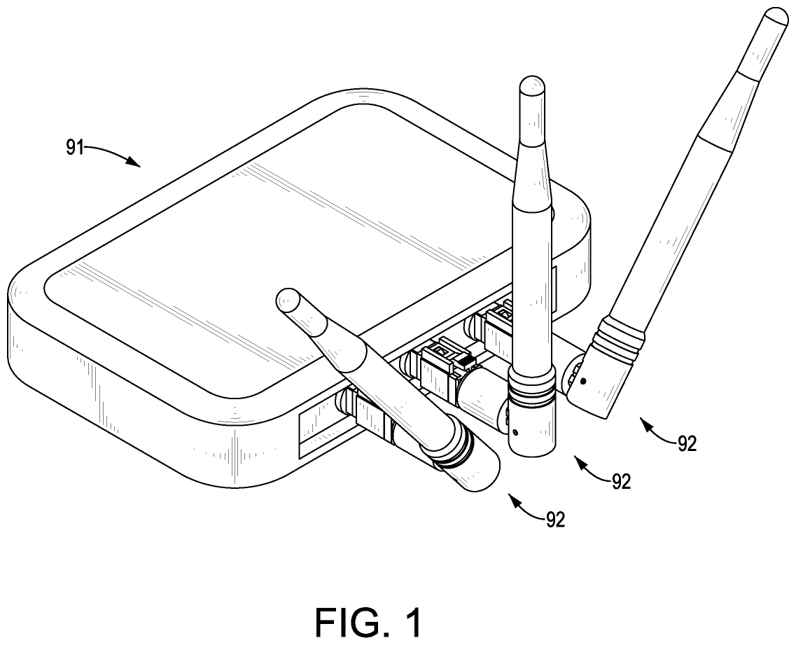

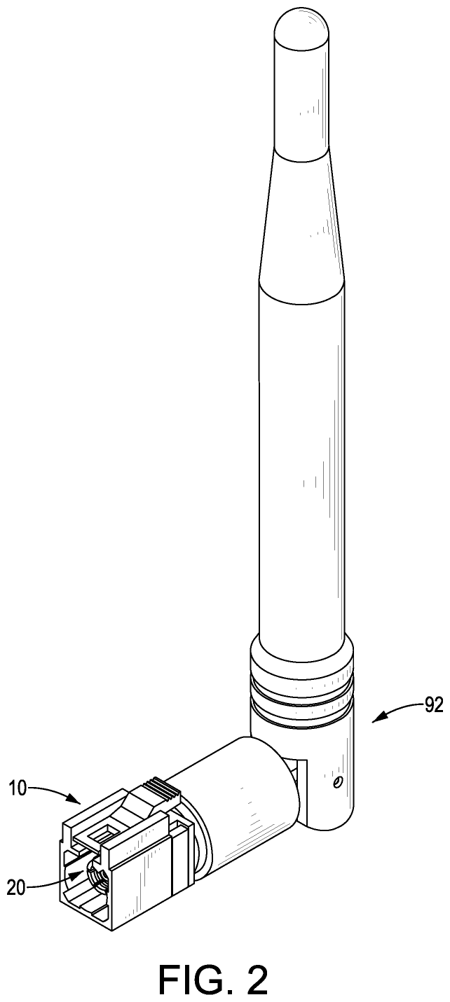

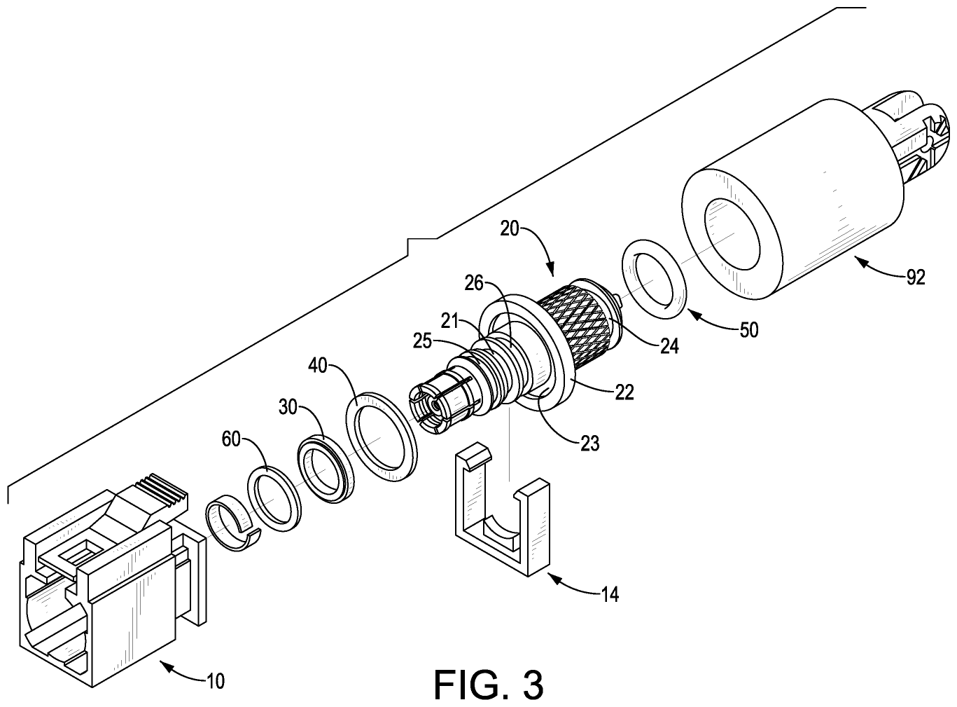

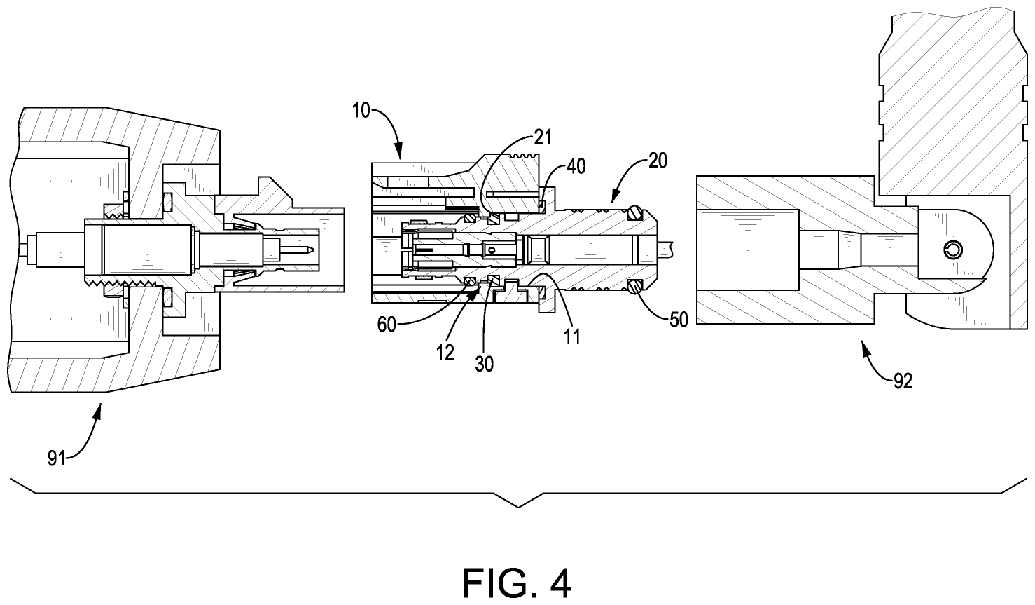

With reference to FIG. 1 to FIG. 4 first, an antenna connector 90 in accordance with the present invention is configured to electrically connect an antenna 92 and a device 91. The antenna connector 90 comprises a casing 10, a shaft 20, a first rubber ring 30, a second rubber ring 40, a first waterproof gasket 50, and a second waterproof gasket 60. The device 91 is securely mounted on the casing 10, and the shaft 20 is rotatably mounted through the casing 10. The antenna 92 is securely mounted on the shaft 20 and therefore synchronously rotates with the shaft 20 when the shaft 20 is rotating. The device 91 can be, but is not limited to, a router, a signal source, a transmission wire, a base station, or a circuit tester.

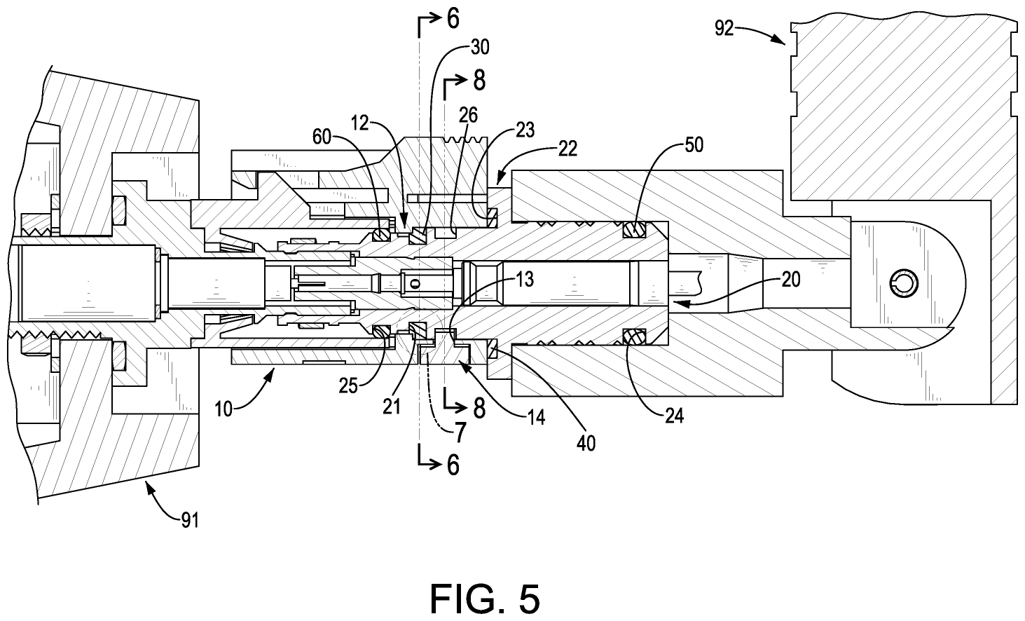

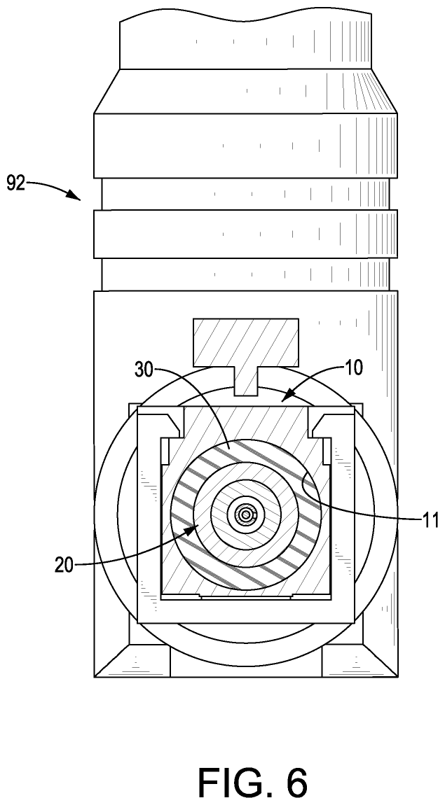

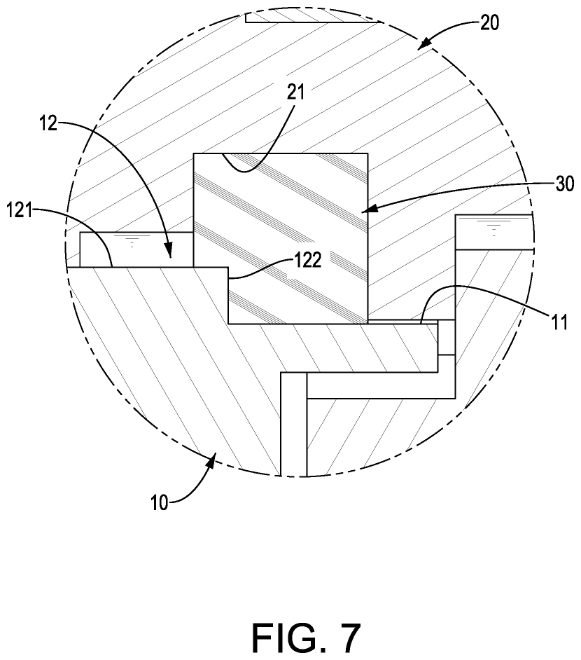

With reference to FIG. 5 to FIG. 7, the casing 10 comprises a perforation 11 and a first flange 12. A cross-section of the perforation 11 is circular. The first flange 12 is a loop and is mounted on a surface of the perforation 11. The first flange 12 comprises a first contact surface 121 and a second contact surface 122. A space surrounded by the first flange 12 is also circular in cross-section. In this embodiment, the first contact surface 121 is a cylindrical surface and is parallel to the surface of the perforation 11. The second contact surface 122 connects vertically to the first contact surface 121 and the surface of the perforation 11. The second contact surface 122 is a surface on the first flange 12 and is closer to the antenna 92 than the first contact surface 121. In another embodiment, the first contact surface 121 does not need to be parallel to the surface of the perforation 11. The second contact surface 122 does not need to be perpendicular to the first contact surface 121 or the surface of the perforation 11.

The shaft 20 is circular in cross-section. The shaft 20 is mounted through the perforation 11 and can rotate relative to the casing 10. The antenna 92 is securely mounted on the shaft 20 and therefore synchronously rotates with the shaft 20 when the shaft 20 is rotating. The shaft 20 comprises a first groove 21, a second flange 22, a second groove 23, a third groove 24, a fourth groove 25, and a fifth groove 26.

The first groove 21 surrounds and is formed on an outer surface of the shaft 20. The first rubber ring 30 is located in the first groove 21. The first rubber ring 30 fits the first groove 21, the surface of the perforation 11, and the first contact surface 121 and the second contact surface 122 of the first flange 12. In other words, the first rubber ring 30 is exerted with multi-directional compression forces from the first groove 21, the surface of the perforation 11, the first contact surface 121 and the second contact surface 122 at the same time. Therefore, the first groove 21 and the surface of the perforation 11 apply one axial compression force to the first rubber ring 30, the first groove 21 and the first contact surface 121 apply another axial compression force to the first rubber ring 30, and the first groove 21 and the second contact surface 122 apply one radial compression force to the first rubber ring 30.

The second flange 22 surrounds and is mounted on the outer surface of the shaft 20. The second flange 22 is located between the antenna 92 and the casing 10, and the second flange 22 fitly contacts the casing 10. In this embodiment, the casing 10 further comprises a third contact surface 15. The third contact surface 15 oppositely faces toward the antenna 92 and is perpendicular to the outer surface of the shaft 20. The second flange 22 fitly contacts the third contact surface 15. The second groove 23 is formed on a surface of the second flange 22. The second groove 23 is located between the second flange 22 and the casing 10. It means that an opening of the second groove 23 is directly opposite the third contact surface 15. The second rubber ring 40 is located in the second groove 23. The second rubber ring 40 fits the second groove 23 and the third contact surface 15. In another embodiment, the third contact surface 15 does not need to be perpendicular to the surface of the shaft 20. In another embodiment, the second rubber ring 40 is capable of being clamped between the casing 10 and the shaft 20. A compression force applied by the casing 10 and the shaft 20 on the second rubber ring 40 is not limited to radial or axial compression.

Both the third groove 24 and the fourth groove 25 surround and are formed on the outer surface of the shaft 20. An opening of the third groove 24 is directly opposite the antenna 92. The first waterproof gasket 50 is located in the third groove 24, and the first waterproof gasket 50 fits the third groove 24 and the antenna 92. Therefore, the first waterproof gasket 50 can prevent moisture or dust from seeping into a gap between the shaft 20 and the antenna 92. An opening of the fourth groove 25 is directly opposite the device 91. The second waterproof gasket 60 is located in the fourth groove 25, and the second waterproof gasket 60 fits the fourth groove 25 and the device 91. Similarly, the second waterproof gasket 60 can prevent moisture or dust from seeping into a gap between the shaft 20 and the device 91.

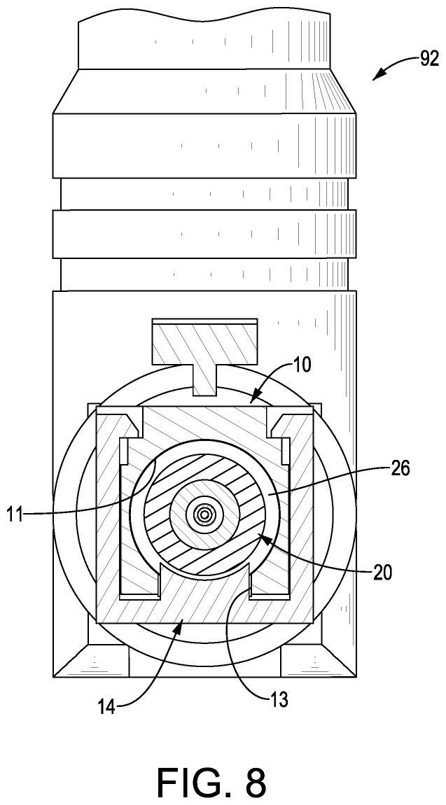

With reference to FIG. 5 and FIG. 8, the casing 10 further comprises a hole 13 and a tenon 14. The fifth groove 26 surrounds and is formed on the surface of the shaft 20. The hole 13 penetrates from the perforation 11 to the casing 10 and corresponds to the fifth groove 26 in location. The tenon 14 is mounted through the hole 13 and embedded in the fifth groove 26. Therefore, the shaft 20 cannot separate from the casing 10.

The benefit of the present invention is that both the first rubber ring 30 and the second rubber ring 40 get compression forces from the shaft 20 and the casing 10. Precisely, in this embodiment, the first groove 21 and the surface of the perforation 11 apply one axial compression force to the first rubber ring 30, the first groove 21 and the first contact surface 121 apply another axial compression force to the first rubber ring 30, and the first groove 21 and the second contact surface 122 apply one radial compression to the first rubber ring 30. The second groove 23 and the third contact surface 15 apply one radial compression force to the second rubber ring 40. Therefore, as the antenna 92 is rotating, the first rubber ring 30 and the second rubber ring 40 can provide a larger torque to prevent the antenna 92 from falling with the gravity due to the heavy weight of the antenna 92.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. An antenna connector configured to electrically connect an antenna and a device; the antenna connector comprising:
a casing located between the antenna and the device, securely mounted on the device, and comprising:
a perforation, a cross-section of the perforation being circular;
a first flange being a loop and mounted on a surface of the perforation; the first flange comprising:
a first contact surface being a cylindrical surface and being parallel to the surface of the perforation;
a second contact surface connecting the first contact surface and the surface of the perforation; the second contact surface being a surface on the first flange and being closer to the antenna than the first contact surface;
a shaft, a cross-section of the shaft being circular; the shaft mounted through the perforation and being rotatable relative to the casing; the antenna securely mounted on the shaft; the shaft comprising:
a first groove surrounding and formed on an outer surface of the shaft;
a second flange surrounding and mounted on the outer surface of the shaft and located between the antenna and the casing; the second flange fitly contacting the casing;
a second groove formed on a surface of the second flange, and located between the second flange and the casing;
a first rubber ring fitting the first groove, the surface of the perforation, and the first contact surface and the second contact surface of the first flange; and
a second rubber ring fitting the second groove and the casing.

2. The antenna connector as claimed in claim 1, wherein the casing comprises:
a third contact surface oppositely facing toward the antenna and being perpendicular to an axis of the shaft; the second flange fitly contacting the third contact surface.

3. The antenna connector as claimed in claim 1, wherein:
the shaft comprises a third groove; the third groove surrounds and is formed on the outer surface of the shaft, and is located between the shaft and the antenna;
the antenna connector further comprises a first waterproof gasket; the first waterproof gasket fits the third groove and the antenna.

4. The antenna connector as claimed in claim 2, wherein:
the shaft comprises a third groove; the third groove surrounds and is formed on the outer surface of the shaft, and is located between the shaft and the antenna;
the antenna connector further comprises a first waterproof gasket; the first waterproof gasket fits the third groove and the antenna.

5. The antenna connector as claimed in claim 1, wherein:
the shaft comprises a fourth groove; the fourth groove surrounds and is formed on the outer surface of the shaft, and is located between the shaft and the device;
the antenna connector further comprises a second waterproof gasket; the second waterproof gasket fits the fourth groove and the device.

6. The antenna connector as claimed in claim 4, wherein:
the shaft comprises a fourth groove; the fourth groove surrounds and is formed on the outer surface of the shaft, and is located between the shaft and the device;
the antenna connector further comprises a second waterproof gasket; the second waterproof gasket fits the fourth groove and the device.

7. The antenna connector as claimed in claim 1, wherein:
the shaft comprises a fifth groove; the fifth groove is formed on the outer surface of the shaft;
the casing comprises:
a hole penetrating from the perforation to the casing and corresponding to the fifth groove in location;
a tenon mounted through the hole and embedded in the fifth groove.

8. The antenna connector as claimed in claim 6, wherein:
the shaft comprises a fifth groove; the fifth groove is formed on the outer surface of the shaft;
the casing comprises:
a hole penetrating from the perforation to the casing and corresponding to the fifth groove in location;
a tenon mounted through the hole and embedded in the fifth groove.
